(19) United States
(12) Patent Application Publication
(10) Pub. No.: US 2003/0121935 A1
(43) Pub. Date: Jul. 3, 2003

(54) Gasket for use in a metering valve that limits seal intrusion

(76) Inventors: Cathleen M. Arsenault, Hugo, MN (US); Andrew M. Bryant, Quorn (GB); Peter D. Hodson, Breaston (GB); Charles G. Thiel, Maplewood, MN (US); Matthew J. Wilby, Loughborough (GB)

Correspondence Address: 3M INNOVATIVE PROPERTIES COMPANY, PO BOX 33427, ST. PAUL, MN, 55133-3427, US

(21) Appl. No.: 10/334,376

(22) Filed: Dec. 30, 2002

Related U.S. Application Data
(60) Provisional application No. 60/344,990, filed on Dec. 31, 2001.

(51) Int. Cl. G01F 11/00

(52) U.S. Cl. 222/1; 222/402.24; 222/402.25

(57) ABSTRACT

Gaskets for use in a metering valve are described herein. The gaskets include one or more gasket-protective components that are designed to limit the likelihood and extent to which the gasket can intrude into an opening such as the channel opening of a valve stem. The one or more gasket protective-components also limit the likelihood and extent of damage caused by repeated use of the metering valve.

### RELATED APPLICATION DATA

This application claims priority to U.S. Provisional Patent Application Ser. No. 60/344,990, filed Dec. 31, 2001.

### BACKGROUND

Metering valves are a common means by which aerosols are dispensed from aerosol containers. Metering valves are particularly useful for administering medicinal formulations that may include a liquefied gas propellant and are delivered to a patient in an aerosol.

When administering medicinal formulations, a dose of formulation sufficient to effect the desired physiological response is delivered to the patient. The proper, predetermined amount of the formulation must be dispensed to the patient in each successive dose. Thus, any dispensing system must be able to dispense doses of the medicinal formulation accurately and reliably to help assure the safety and efficacy of the treatment.

Metering valves have been developed to provide control over the dispensing of medicinal aerosol formulations. A metering valve regulates the volume of a medicinal formulation passing from a container to a metering chamber. A metering chamber typically is formed in a space between a structural portion of the metering valve such as a valve body and a moveable portion of the metering valve such as a valve stem. The metering chamber also may be defined, in part, by one or more fluid tight seals, each of which may be formed between, for example, an annular gasket and the valve stem. One such annular gasket may be a metering gasket that serves to isolate the metering chamber from a container holding the bulk formulation. Each seal generally is designed to remain fluid tight even when the valve stem slides past the gasket when the valve stem is actuated. A gasket and the valve stem generally are configured so that each conforms to the shape of the other, thereby facilitating the desired fluid tight seal. Depending upon the particular design of the metering valve, the metering chamber may be formed prior to or during actuation of the valve stem.

However, the valve stem may include additional surface features that may cause deterioration of the fluid tight seal between a gasket and the valve stem upon repeated actuation of the valve stem. For example, the valve stem may include an internal channel through which formulation flows in order to fill the metering chamber. The channel opening may have one or more sharp edges that can damage a metering gasket upon repeated actuation of the valve stem.

Damage to a gasket such as a metering gasket can degrade the seal between the gasket and the valve stem, thereby corrupting dose metering, contaminating the formulation with particles of gasket material, or both. Damage to a gasket may also block or partially block delivery of the formulation. This may occur directly, such as by accumulation of gasket fragments. Alternatively, the effect may be indirect; abraded gasket particles may act as “seeding” for precipitation or deposition of the formulation. Delivery of formulation may be completely or partially blocked by accumulated gasket particles, precipitated or deposited formulation, or both. Also, damage to a gasket may result in increased, unpredictable or uneven friction forces between the valve stem and the gasket. Such damage may require more force to actuate the metering valve to obtain a dose of formulation or otherwise adversely affect operation of the metering valve, resulting in inconsistent or improper dosing of formulation.

A related problem observed in some metering valves is that of seal intrusion, i.e., a gasket such as a metering gasket may intrude into an opening that exists in a portion of the metering valve. Even if the gasket sustains no substantial damage as a result of seal intrusion, performance of the metering valve may be compromised. For example, after a gasket intrudes into an opening, it must subsequently be removed from the opening in order to allow continued function of the metering valve, either continued actuation or a return to its resting position. Deforming the gasket sufficiently to remove the gasket from the opening may require substantial additional force. Such deforming of the gasket may be sufficient to render the gasket unable to reset the fluid tight seal with the valve stem, thereby compromising performance of the valve stem.

A gasket that intrudes into an opening may become lodged therein if it cannot be completely removed from the opening. This may lead to jamming of the metering valve and, therefore, partial or complete loss of performance. Seal intrusion may require that an inconsistent, or even a consistent but higher, amount of force be applied in order to actuate the metering valve. Thus, metering valves susceptible to seal intrusion may be more difficult for a patient to use properly and, therefore, the patient may fail to obtain the prescribed dose of formulation.

Therefore, a need exists for a gasket for use in an aerosol metering valve that is designed to limit seal intrusion. A further need exists for a gasket designed to limit damage to the metering gasket caused by seal intrusion, particularly upon repeated actuation of the metering valve.

### SUMMARY

The present invention provides a gasket for use in an aerosol metering valve that is designed to limit seal intrusion. As used herein, seal intrusion refers to intrusion of the gasket into an opening in any portion of the metering valve. Seal intrusion may compromise performance of the metering valve. Additionally, seal intrusion may cause damage to the gasket, particularly upon repeated actuation of the metering valve.

Certain metering valves include valve stems that have channel openings designed to improve the flow of formulation through the valve stem, such as short, broad channel openings. Intrusion of the gasket into a short, broad channel opening may be more likely than in connection with other channel opening designs, particularly if the channel opening is aligned along the same plane as the gasket. As the channel opening slides past the gasket during actuation of the valve stem, a portion of the gasket sealing surface may intrude into the channel opening. Such seal intrusion may compromise performance of the metering valve. Thus, performance of the metering valve may be improved by providing one or more structures on the gasket that are designed to limit the likelihood and extent of seal intrusion.

Any portion of the gasket that intrudes into the channel opening also may be susceptible to damage by an edge of the opening as the valve stem is further actuated, returned to the resting position, or both. Therefore, damage to the gasket may be reduced by providing structures on the gasket that are designed to reduce the likelihood and extent of seal intrusion. Alternatively, the gasket may include structures that are designed to assist the gasket in moving past an edge of the channel opening in a manner that limits damage to the gasket caused by seal intrusion.

Accordingly, the present invention provides a gasket for use in a metering valve that includes: an elastomeric body including: a perimeter surface, and a major surface that defines a horizontal plane and a central axis generally perpendicular to the horizontal plane; an aperture through the elastomeric body, the aperture defining an annular surface; at least one sealing surface including the perimeter surface or the annular surface; and a gasket-protective component configured to limit seal intrusion. The gasket-protective component may include, for example, a tab projecting from the major surface of the gasket, or some other structural feature, such as a rounded sealing surface, an angled sealing surface, a chiseled sealing surface, or a sealing surface that has a thickness greater than the height of an opening of a valve stem of the metering valve.

In another aspect, the present invention provides a method of reducing intrusion of a metering gasket into an outlet opening of a metering valve by reconfiguring the metering gasket to include one or more gasket-protective components.

### BRIEF DESCRIPTION OF THE DRAWINGS

FIG. 1 is a cross-sectional view of an aerosol metering valve.

FIG. 2 is an isometric view of a metering gasket according to the present invention.

FIG. 3 illustrates an alternative embodiment of a metering gasket according to the present invention.

FIG. 4 illustrates another alternative embodiment of a metering gasket according to the present invention.

FIG. 5 illustrates another alternative embodiment of a metering gasket according to the present invention.

FIG. 6 illustrates another alternative embodiment of a metering gasket according to the present invention.

FIG. 7 is an enlarged cross-sectional view of another alternative embodiment of the present invention.

FIG. 8 is an enlarged cross-sectional view of another alternative embodiment of the present invention.

FIG. 9 is an enlarged cross-sectional view of another alternative embodiment of the present invention.

### DETAILED DESCRIPTION OF ILLUSTRATIVE EMBODIMENTS OF THE INVENTION

The following description is set forth in terms of aerosol metering valves used to dispense an aerosol formulation from an aerosol container. However, the features of the present invention are equally applicable to any gasket for use in any device in which a gasket is designed to occlude or seal an opening and in which the gasket may intrude into the opening. For example, the features of the present invention may be applicable to other gaskets in a metering valve, e.g., a housing gasket. In particular, the metering valve designs described herein may be useful in devices designed for dispensing medicinal aerosol formulations.

Also, the present invention is described herein with respect to a single general metering valve design having a metering gasket that occludes a channel opening and a metering chamber that is formed upon actuation of the valve stem (a “transient metering chamber”). However, the features of the present invention are equally applicable to alternative metering valve designs in which a gasket of any type or for any function is designed to occlude or seal an opening, whether the opening is in a surface of a valve stem or elsewhere in the metering valve, and in which the gasket may intrude into the opening. Such alternative designs include other designs having a transient metering chamber as well as designs having a metering chamber that is at least partially formed prior to actuation of the valve stem.

For example, the present invention is described with respect to a metering valve in which a sealing surface of the metering gasket forms a slidable seal with at least a portion of a valve stem. However, the features of the present invention are equally applicable to a metering valve design in which the metering gasket is affixed to the valve stem and the sealing surface of the metering gasket is located on the perimeter surface of the gasket, thereby forming a slidable seal with at least a portion of a chamber wall of the metering valve. Such metering valves are described in U.S. Pat. No. 5,772,085, issued Jun. 30, 1998, to the assignee of the present invention.

The present invention is directed to gaskets such as those used in a metering valve. The gaskets of the present invention include at least one gasket-protective component designed to limit seal intrusion, i.e., intrusion of the gasket into an opening (such as a channel opening of a valve stem) in a portion of the metering valve. As used herein, “gasket-protective component” refers to any design feature of the metering gasket that may serve to limit seal intrusion. A gasket that has intruded into an opening may compromise performance of the metering valve by, for example, becoming lodged, requiring increased force to become dislodged, becoming deformed such that it cannot reset a fluid tight seal, or becoming damaged. Thus, gaskets that have a gasket-protective component may contribute to improved performance of the metering valve.

Gasket-protective components may include, but are not limited to, structures specifically designed to guide the metering gasket across such an opening, design features such as surface contours and gasket thickness, and means for retaining the gasket in a position that reduces the likelihood and extent of seal intrusion.

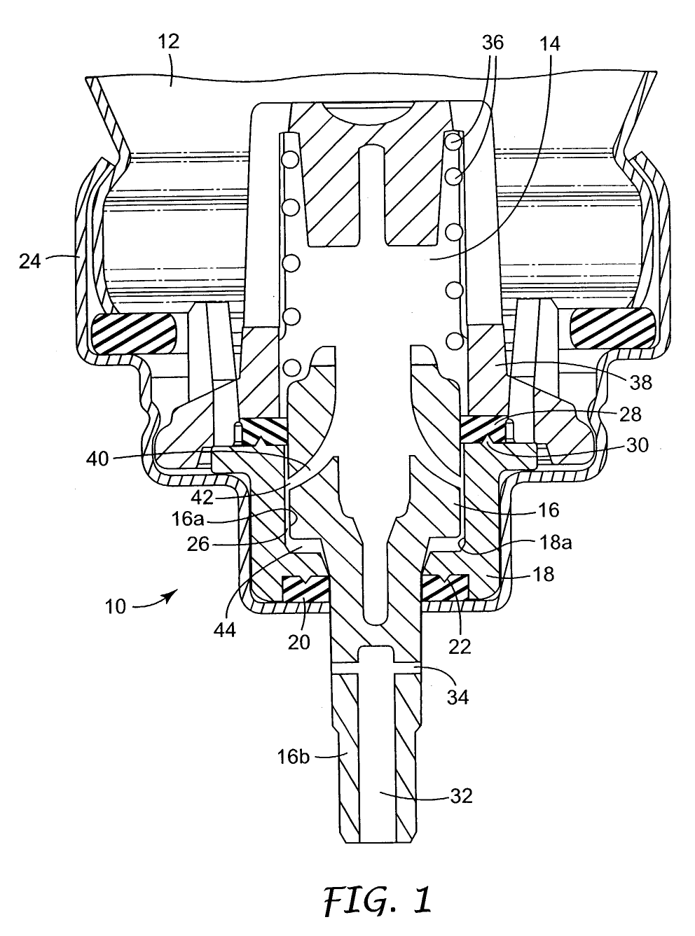

A metering valve 10 of a type that may include a gasket according to the present invention is shown generally in FIG. 1. One end of the metering valve 10 is in fluid communication with a conventional aerosol container 12 (partially shown). Thus, aerosol formulation may be dispensed downwardly from the aerosol container 12 and through the metering valve 10 for delivery to a patient. Such delivery may be through a discharge piece (not shown) that may be designed to direct the aerosol formulation toward the body cavity or skin area to which the formulation is to be delivered. For example, the discharge piece may be a mouthpiece that can be inserted into the patient's mouth, thereby providing oral administration of the aerosol formulation for inhalation by the patient.

The metering valve 10 may include an interior chamber 14, a portion of which is occupied by the valve stem 16. One or more inlets may provide open and unrestricted fluid communication between the interior chamber 14 and the aerosol container 12.

The valve stem 16 generally includes a body portion including a side wall 16a. A stem portion of the valve stem 16b extends through an aperture in, and is in slidable, sealing contact with, a housing gasket 20. The stem portion of the valve stem 16b may include a discharge outlet 32 through which a metered dose of formulation may be discharged. The discharge outlet 32 may include one or more side holes 34.

The metering valve 10 may include a valve body 18 that includes a valve body wall 18a. The body portion of the valve stem 16 may be configured generally to have substantially the same shape as, but to be slightly smaller than, the valve body wall 18a that surrounds the valve stem body 16.

In the metering valve 10 shown in FIG. 1, an annular gap 26 is formed between the valve body wall 18a and the side wall of the valve stem 16a. When the valve stem 16 is actuated, the valve stem 16 is displaced into the interior chamber 14 of the metering valve 10 and a space is created between the valve stem 16 and the valve body 18, as shown in FIG. 1. The space thus created is the metering chamber 44. The valve stem 16 may fit concentrically inside the valve body 18 and provides sufficient clearance to allow formulation to flow between the valve stem 16 and the valve body 18 and into the metering chamber 44.

A spring 36 may be provided within the interior chamber 14 of the metering valve 10. The spring 36 serves to bias the valve stem 16 toward a resting position, i.e., the position assumed by the metering valve between uses. The spring 36 thus provides a means for returning the valve stem to the resting position after the stem is actuated and the dose of formulation is discharged. However, any suitable means for biasing the valve stem 16 to the resting position may be used.

The metering valve 10 shown in FIG. 1 also includes at least two annular gaskets, the metering gasket 28 and the housing gasket 20. The housing gasket 20 is positioned between a valve housing 24, the valve body 18 and the valve stem 16. The housing gasket 20 isolates the formulation in the aerosol container 12 from the exterior of the valve by forming two fluid tight seals: 1) an annular seal between the housing gasket 20 and the stem portion of the valve stem 16a, and 2) a compressive planar or face seal between the housing gasket 20 and the housing 24. The latter seal may be effected either with or without a sealing bead 22 on the valve body 18, the housing 24 or both.

The metering gasket 28 is positioned between the valve body 18, the spring cage 38, and the side wall of the valve stem 16a. The metering gasket 28 transiently isolates the formulation in the metering chamber 44 from the aerosol container 12 by forming two fluid tight seals: 1) an annular seal between the metering gasket 28 and the side wall of the valve stem 16a, and 2) a compressive planar or face seal between the metering gasket 28 and the valve body 18. The latter seal may be effected either with or without a sealing bead 30 on the valve body 18, the spring cage 38 or both. The metering gasket 28 provides a means for terminating the flow of formulation from the aerosol container 12 to the metering chamber 44 during actuation of the valve stem 16.

The metering gasket may be constructed of any suitable material. Metering gaskets are commonly constructed of thermoset rubbers such as butyl rubber, butadiene-acrylonitrile rubbers and neoprene (polychloroisoprene), which may be compounded with vulcanizing agents prior to being fashioned into a metering gasket. Additional suitable materials include polyolefin/rubber blends such as those described in International Publication No. WO 95/03984, published Feb. 9, 1995.

The metering valve 10 shown in FIG. 1 is operated by displacing the valve stem 16 inwardly into the interior chamber 14 against the compressive force of the spring 36. As the valve stem 16 is displaced inwardly, the metering chamber 44 is formed between the valve body 18 and the valve stem 16. The volume of the metering chamber 44 increases as the valve stem 16 is displaced. As the metering chamber 44 is formed, aerosol formulation flows from the aerosol container 12 to the metering chamber 44.

In the metering valve 10 shown in FIG. 1, formulation flows from the aerosol container 12 to the metering chamber 44 by passing through the valve stem 16 via one or more channels 40 having one or more channel openings 42. However, other metering valves may include valve stems that define alternative flow paths for the formulation to traverse as it flows from the aerosol container to the metering chamber. Such metering valves also may employ one or more gaskets that help regulate or control the movement of formulation through or past a valve stem to a metering chamber. Gaskets according to the present invention may be useful in such metering valves.

For the metering valve 10 shown in FIG. 1, aerosol formulation may enter the metering chamber 44 in the following manner. Formulation from the aerosol container 12 passes through one or more metering valve inlets and into the interior chamber 14 of the metering valve. From the interior chamber 14, the formulation passes through the one or more channels 40 in the valve stem 16, then through one or more channel openings 42 and the annular gap 26 and into the metering chamber 44.

Eventually, the valve stem 16 is displaced far enough into the interior chamber 14 so that the metering gasket 28 occludes the channel opening 42, thereby cutting off the flow path of formulation. The metering gasket 28 forms a fluid-tight seal around the valve stem 16 that prevents any additional flow of formulation to the metering chamber 44 and thereby terminates filling of the metering chamber 44.

As the metering gasket 28 occludes the channel opening 42 it also may intrude into the channel opening 42. A metering gasket 28 that has intruded into the channel opening 42 may compromise performance of the metering valve as described above, including becoming damaged by an edge of the channel opening 42 as the valve stem 16 is actuated further during normal operation. Repeated actuation of the valve stem 16 provides repeated opportunities for the metering gasket 28 to be damaged by the channel opening 42 in this way.

Further actuation of the valve stem allows the formulation in the metering chamber 44 to be discharged. As the valve stem 16 is fully actuated, the one or more side holes 34 of the discharge outlet 32 pass through the housing gasket 20 and come into fluid communication with the metering chamber 44. That fluid communication allows the aerosol formulation within the metering chamber 44 to be released into the one or more side holes 34 and the formulation thus passes through the discharge outlet 32, thereby delivering the metered dose of aerosol formulation to the patient or other desired area.

During the discharge of the aerosol formulation from the metering chamber 44, the metering gasket 28 continues to prevent the passage of additional bulk formulation from the aerosol container 12 to the metering chamber 44. After the dose of aerosol formulation is discharged, the patient releases the valve stem 16, which returns to its original resting position by the biasing action of the spring 36.

The foregoing description of the operation of a metering valve is provided as one example of a metering valve design that may benefit from the features of the present invention, described in detail below. However, other metering valve designs also may benefit from the features of the present invention. Any metering valve design having a gasket that occludes an opening may subject the gasket to damage from the opening.

Thus, by employing a gasket having the features of the present invention, such metering valve designs may experience reduced seal intrusion and, therefore, provide improved performance.

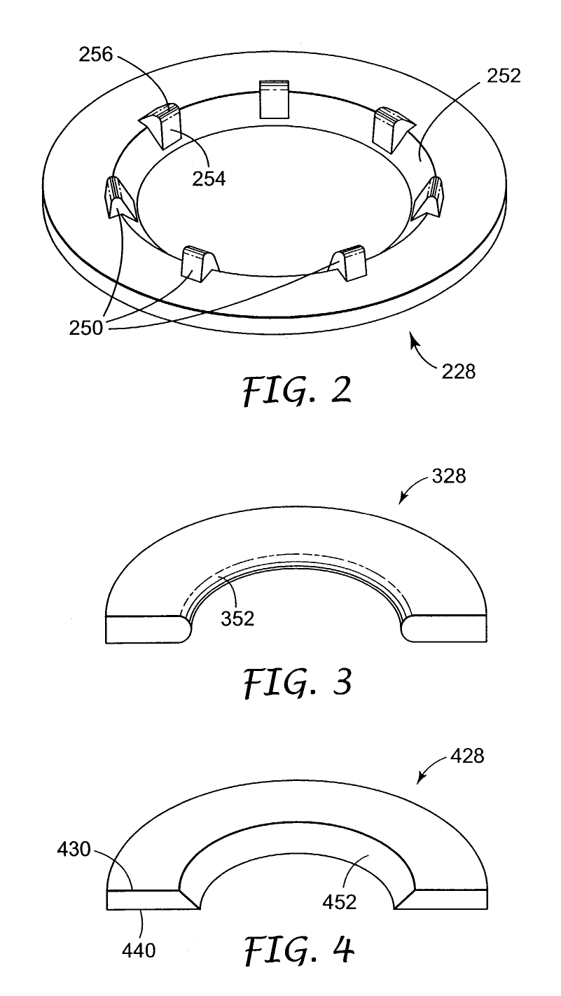

FIG. 2 shows an embodiment of a metering gasket 228 according to the present invention having tabs 250 molded or otherwise affixed to the sealing surface 252 of the metering gasket 228. The tabs 250 may be designed to position the sealing surface 252 with respect to, and guide the sealing surface 252 past, the edge of an opening such as the channel opening of a valve stem, thereby reducing the likelihood and extent to which the metering gasket 228 can intrude into the opening. In one embodiment, shown in FIG. 2, each tab 250 includes a leading edge 256 and a guiding surface 254. The guiding surface 254 may be angled such that a plurality of tabs 250 form a discontinuous funnel that helps guide the sealing surface 252 past the opening while limiting the extent to which the metering gasket 228 can intrude into the opening. An alternative embodiment may include a single, continuous tab that forms a ring around the entire annular edge of the metering gasket 28. The tabs 250 or ring may be angled, as shown in FIG. 2, vertical with respect to the sealing surface 252 of the metering gasket 228, vertical with a flare at the leading edge of the tab 250, or any other shape or arrangement that may help guide the metering gasket 228 past the opening.

Tabs 250 projecting from one surface of the metering gasket 228 may guide the metering gasket 228 past the opening in one direction, such as when the metering gasket moves past a channel opening during actuation of a valve stem. A second set of tabs 250 may be present projecting from the opposite surface of the metering gasket for guiding the metering gasket past the opening in the opposite direction, such as when the metering gasket moves past the channel opening as a valve stem returns to its resting position between uses.

The tabs 250 may be made from the same material as the metering gasket 228, from different material, or any mixture thereof. The leading edge 256 of a tab 250 may be rounded to reduce the likelihood that the opening may damage the tab 250.

A metering gasket 228 including one or more tabs 250 may be included in a metering 10 valve such as that shown in FIG. 1. In such an embodiment, the one or more tabs 250 may fit into one or more recesses in the spring cage 38, valve body 18, or both.

In certain embodiments, a gasket having tabs 250 may be used in a metering valve in connection with a valve stem including one or more gasket-protective components of its own. Such valve stems may include one or more ribs, for example, that at least partially traverse the channel opening. Such valve stems are described in U.S. Provisional Ser. No. 60/345,411, filed on Dec. 31, 2001.

A metering valve that includes a gasket and a valve stem, each including at least one gasket-protective component, may be designed so that no matter how the gasket and the valve stem are rotationally aligned, the total cross-sectional area of the channel openings available for the flow of formulation remains substantially similar. This may be so even though one or more tabs may at least partially occlude one or more channel openings. The metering valve may be designed so that whatever the rotational alignment of the valve stem and the gasket, a substantially similar surface area of the channel openings is occluded by the tabs.

In the embodiment shown in FIG. 3, the sealing surface 352 of the metering gasket 328 includes a rounded profile. Such a rounded profile may help to guide the metering gasket 328 past an opening such as the channel opening of a valve stem, thereby reducing the extent of seal intrusion during actuation of the metering valve. In one such embodiment, the metering gasket 328 forms an O-ring.

In the embodiment shown in FIG. 4, the metering gasket 428 includes a sealing surface 452 that is angled to help guide the metering gasket 428 past an opening such as the channel opening of a valve stem. Such a metering gasket 428 may be constructed to have a leading surface 430 and a trailing surface 440. As used herein, “leading surface” refers to the surface that faces the direction that the gasket is moving relative to the opening as it moves past the opening, i.e., the surface on the side of the gasket that first at least partially occludes the opening. As used herein, “trailing surface” is the surface of the gasket opposite the leading surface, whether or not the trailing surface ever contacts an edge of the opening. The angled sealing surface 452 connects the leading surface 430 and the trailing surface 440. To form the angled sealing surface 452, the gasket may be wider at the trailing surface 440 than at the leading surface 430.

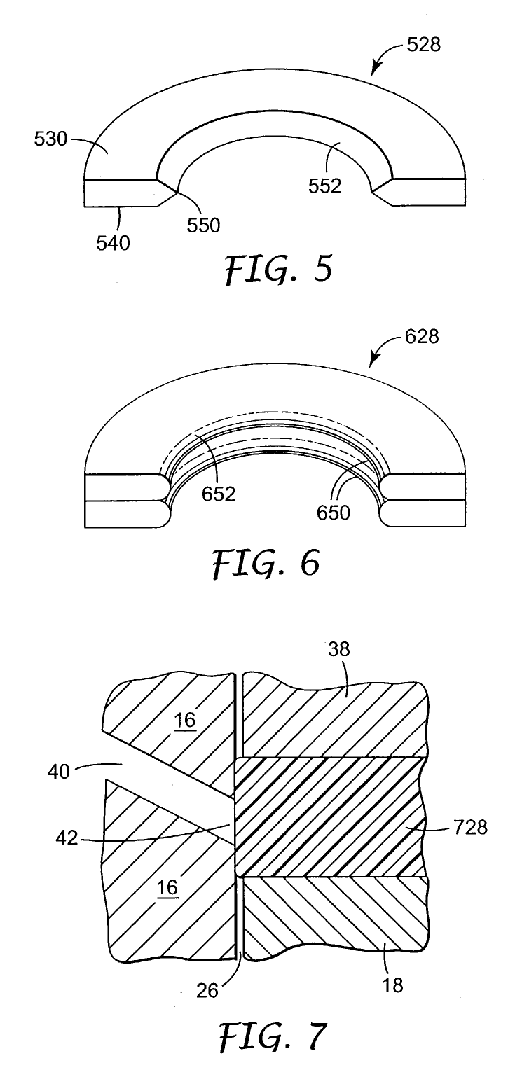

Alternatively, an angled sealing surface may include a chiseled sealing surface 552, as shown in FIG. 5. In such an embodiment, the leading surface 530 and the trailing surface 540 may have substantially similar widths. However, an apex 550 extends toward the center of the aperture formed by the metering gasket. The apex 550 may form a point, may be rounded, may be flattened to form a plateau-like structure, or any other suitable structure so that some portion of the sealing surface 552 defines an aperture diameter that is less than the diameter defined across the aperture measured from either of the leading surface 530 or the trailing surface 540.

The apex 550 may be positioned in the center of the sealing surface 550 or off-center. Also, as shown in FIG. 6, the sealing surface 652 may include more than one apex 650.

In each of the embodiments shown in FIGS. 3-6, the sealing surface may be designed to help guide the gasket past an opening on a valve stem, thereby limiting the likelihood and extent of seal intrusion and, thereby, also limiting damage to the gasket resulting from seal intrusion. Also, the embodiments illustrated in FIGS. 3-6 may be designed so that in the event of seal intrusion, the gasket may be more easily guided back out of the opening, thereby reducing the force necessary to remove the gasket from the opening and also thereby reducing the variation in force required to activate the metering valve, both of which may lead to improved performance of the metering valve.

FIG. 7 illustrates an embodiment of the present invention in which the metering gasket 728 is configured to have a thickness that is greater than the height of an opening such as the channel opening 42 of a valve stem 16 to an extent sufficient to reduce the likelihood and extent to which the metering gasket 728 can intrude into the opening. Such a metering gasket 728 may more easily span the height of the channel opening 42, thereby reducing the likelihood and extent that the metering gasket 728 could intrude into the opening and, therefore, reduce the likelihood and extent of damage to the gasket.

The thickness of the gasket with respect to the height of the opening may depend, in part, upon the material used to construct the metering gasket 728. For example, metering gaskets constructed from relatively more flexible materials, i.e., having a Shore A value from about 40 to about 55, may require relatively more support from the valve stem 16 in order to reduce the likelihood and extent of seal intrusion. Thus, such metering gaskets may be substantially thicker than the height of the opening 42. Alternatively, metering gaskets 728 constructed from relatively more rigid materials, i.e., having a Shore A value from about 65 to about 85, may be less susceptible to seal intrusion. Therefore, metering gaskets constructed from such materials may not require as much support provided by the valve stem 16 in order to reduce the likelihood and extent of seal intrusion. Thus, such metering gaskets may be thicker than the height of the opening 42, but to a lesser extent than metering gaskets constructed from relatively more flexible material.

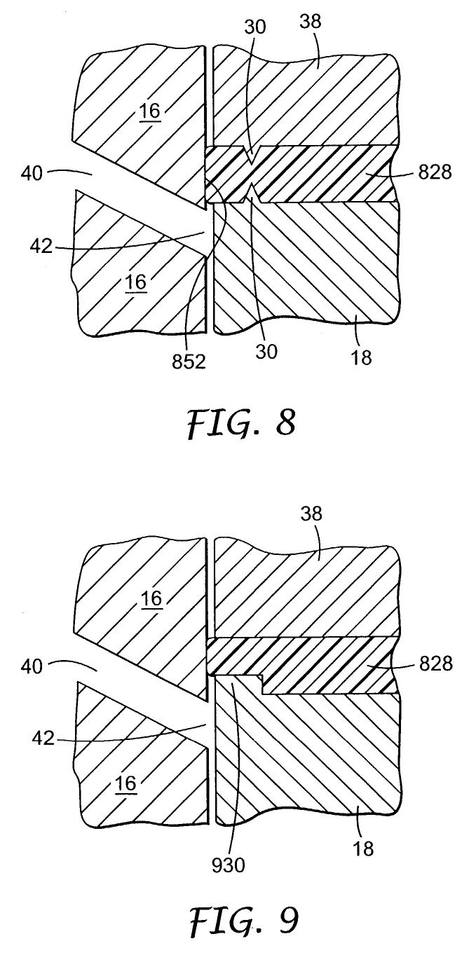

FIG. 8 shows a longitudinal cross-sectional view of one embodiment of a metering valve according to the present invention. In this embodiment, one or more sealing beads 30 are used to anchor the metering gasket 828, thereby reducing the extent to which the metering gasket 828 is able to intrude into an opening such as the channel opening 42 of a valve stem. The one or more sealing beads 30 may be in the form of a sharp ridge positioned close to the sealing surface 852 of the metering gasket 828. The sealing bead 30 serves to grip the metering gasket 828 and thereby prevent the sealing surface 852 of the metering gasket 828 from bulging significantly inwards as a result of valve crimping forces, swelling, etc. Such phenomena may increase the likelihood and the extent of seal intrusion and may be mitigated to some extent by the use of one or more sealing beads.

The one or more sealing beads 30 may be located on the valve body 18, the spring cage 38, or sealing beads may be located on both. The sealing bead 30 may form a continuous ring, be discontinuous, or include a plurality of spikes. Alternatively, the one or more sealing beads may be in the form of a step 930, shown in FIG. 9, in the valve body 18, the spring cage 38, or both that is positioned sufficiently close to the sealing surface of the metering gasket 852 that the one or more sealing beads 930 hold the metering gasket 828 in a position that reduces the likelihood and extent of seal intrusion.

Alternatively, the one or more sealing beads 30 may include one or more ridges or spikes of the metering gasket that are secured in one or more recesses in the spring cage 38, valve body 18, or both.

Regardless of the specific design of the one or more sealing beads 30, the one or more sealing beads 30 may be positioned so that the sealing surface 852 of the metering gasket 828 is anchored in a position that provides reliable and consistent sealing. For example, the one or more sealing beads 30 may be positioned a distance from the sealing surface 852 that is 1.5 times the height of the opening 42. In alternative embodiments, the one or more sealing beads 30 may be positioned a distance from the sealing surface that is 1.25 times or 1.0 times the height of the opening 42.

The gaskets described above each limit seal intrusion without putting any constraints on the size, shape, or arrangement of the opening. Thus, in an aerosol metering valve having a gasket that includes any one or more of the features described above permits the channel openings in the valve stem of the metering valve to be designed to provide optimal flow of formulation without regard to reducing damage to the metering gasket.

Each of the embodiments described herein may be used alone or in combination with one or more additional embodiments in order to limit the likelihood or extent to which the metering gasket intrudes into an opening such as the channel opening of a valve stem, e.g., in a metered dose inhaler, to a degree suitable for a desired use, thereby also reducing the likelihood and extent of damage to the metering gasket caused by seal intrusion, particularly upon repeated actuation the metering valve. The embodiments described herein may reduce seal intrusion while allowing other parts of the metering gasket to move with less constraint in response to stresses such as those induced by swelling in the presence of a medicament formulation.

Also, each of the embodiments described herein may be used in combination with one or more gasket-protective structures located on a portion of the metering valve, e.g., the valve stem, to further limit the likelihood and extent of seal intrusion.

The complete disclosures of the patents, patent documents, and publications cited herein are incorporated by reference in their entirety as if each were individually incorporated. In case of conflict, the present specification shall control.

Various modifications and alterations to this invention will become apparent to those skilled in the art without departing-from the scope and spirit of this invention. It should be understood that this invention is not intended to be unduly limited by the illustrative embodiments set forth herein and that such embodiments are presented by way of example only with the scope of the invention intended to be limited only by the claims set forth herein as follows.

What is claimed is:

1. A metering gasket for use in a metering valve comprising:
an elastomeric body comprising:
a perimeter surface, and
a major surface that defines a horizontal plane and a central axis generally perpendicular to the horizontal plane;
an aperture through the elastomeric body, the aperture defining an annular surface;
at least one sealing surface comprising the perimeter surface or the annular surface; and
a gasket-protective component configured to reduce intrusion of the gasket into an opening in a portion of the metering valve.

2. The metering gasket of claim 1 wherein the gasket-protective component comprises at least one tab projecting from the major surface.

3. The metering gasket of claim 2 wherein the tab comprises:
a leading edge, and
a guiding surface that connects the leading edge to at least a portion of the sealing surface.

4. The metering gasket of claim 3 wherein the leading edge of at least one tab is at least as far from the central axis as is the portion of the sealing surface to which it is connected by the guiding edge.

5. The metering gasket of claim 3 wherein the leading edge of at least one tab is at least as close to the central axis as is the portion of the sealing surface to which it is connected by the guiding edge.

6. The metering gasket of claim 3 wherein the leading edge is rounded.

7. The metering gasket of claim 3 wherein the gasket-protective component comprises a plurality of tabs.

8. The metering gasket of claim 2 wherein the tab forms a continuous ring projecting vertically from the major surface.

9. The metering gasket of claim I wherein the gasket-protective component comprises a rounded sealing surface.

10. The metering gasket of claim 9 wherein the gasket comprises an O-ring.

11. The metering gasket of claim 1 wherein the gasket-protective component comprises a sealing surface that comprises:
a leading edge, and
a sealing portion, wherein the leading edge is farther from the central axis than is the sealing portion.

12. The metering gasket of claim 1 wherein the gasket-protective component comprises a sealing surface that comprises:
a leading edge, and
a sealing portion, wherein the sealing portion is closer to the central axis than is the leading edge.

13. The metering gasket of claim 1 wherein the sealing surface has a definable thickness and is configured to at least partially occlude at least one opening of a valve stem of the metering valve.

14. The metering valve of claim 13 wherein the opening of the valve stem has a definable height and the gasket-protective component comprises a sealing surface having a thickness that is greater than the height of at least a portion of the opening.

15. A metering gasket for use in a metering valve comprising:
an elastomeric body that comprises:
i) a perimeter surface, and
ii) a major surface that defines a horizontal plane and a central axis generally perpendicular to the horizontal plane;
an aperture through the elastomeric body that defines an annular surface;
at least one sealing surface comprising the annular surface or the perimeter surface; and
means for protecting the gasket from damage by a portion of the metering valve.

16. An aerosol metering valve comprising:
a) a housing that comprises an internal chamber defined by one or more chamber walls, and a housing gasket having walls that define a housing aperture;
b) at least one port through the housing in fluid communication with the internal chamber;
c) an aerosol valve stem that defines a central axis and comprises:
a stem portion that passes through the housing aperture in slidable, sealing engagement with the housing gasket and comprises a discharge outlet, and
a body portion that comprises
i) a body wall that defines an interior space,
ii) an inlet through the body wall in fluid communication with the interior space, and
iii) an outlet through the body wall in fluid communication with the interior space and comprising an opening; and
d) a metering gasket that comprises:
a major surface, at least a portion of which is in sealing engagement with at least a portion of at least one chamber wall of the metering valve housing,
a metering aperture that defines a sealing surface in slidable, sealing engagement with at least a portion of the valve stem body, and
a gasket-protective component.

17. An aerosol metering valve comprising:
a) a housing that comprises an internal chamber defined by one or more chamber walls, and a housing gasket having walls that define a housing aperture;
b) at least one port through the housing in fluid communication with the internal chamber;
c) an aerosol valve stem that defines a central axis and comprises:
a stem portion that passes through the housing aperture in slidable, sealing engagement with the housing gasket and comprises a discharge outlet, and
a body portion that comprises
i) a body wall that defines an interior space,
ii) an inlet through the body wall in fluid communication with the interior space, and
iii) an outlet through the body wall in fluid communication with the interior space and comprising an opening; and
d) a metering gasket in sealing engagement with at least a portion of at least a portion of the valve stem, the metering gasket comprising:
a major surface,
a perimeter surface that defines a sealing surface in slidable, sealing engagement with at least a portion of the chamber wall of the housing, and
a gasket-protective component.

18. A method of reducing intrusion of a metering gasket into an outlet opening of a metering valve, the method comprising:
providing a metering valve that comprises a valve stem, the valve stem comprising at least one outlet opening and at least one sealing portion;
providing a metering gasket that comprises a major surface, an aperture that defines a sealing surface that is in slidable, sealing engagement with at least a portion of the sealing portion of the valve stem; and
reconfiguring the metering gasket to comprise at least one gasket-protective component, the gasket-protective component configured to reduce intrusion of the metering gasket into the outlet opening.

19. A method of reducing intrusion of a metering gasket into an opening of a metering valve, the method comprising:
providing a metering valve that comprises a chamber wall, the chamber wall comprising at least one opening and at least one sealing portion;
providing a metering gasket that comprises a major surface, a perimeter surface that defines a sealing surface that is in slidable, sealing engagement with at least a portion of the sealing portion of the chamber wall; and
reconfiguring the metering gasket to comprise at least one gasket-protective component, the gasket-protective component configured to reduce intrusion of the metering gasket into the opening in the chamber wall.
